(19) United States
(12) Patent Application Publication
(10) Pub. No.: US 2015/0167384 A1
(43) Pub. Date: Jun. 18, 2015

(54) TELESCOPICALLY COLLAPSIBLE FIRE ESCAPE LADDER

(71) Applicant: TELETOWER.COM LIMITED, Woodford Green, Essex (GB)

(72) Inventor: Richard Weston, Halstead (GB)

(73) Assignee: TELETOWER.COM LIMITED, Woodford Green, Essex (GB)

(21) Appl. No.: 14/416,685

(22) PCT Filed: Jul. 11, 2013
(86) PCT No.: PCT/IB2013/055712

§ 371 Date: Jan. 23, 2015

(30) Foreign Application Priority Data
Jul. 25, 2012 (GB) 1213255.1

(51) Int. Cl. E06C 1/38; E06C 9/08; E06C 7/50; E06C 1/34

(52) U.S. Cl. CPC E06C 1/38; E06C 1/34; E06C 9/08; E06C 7/50

(57) ABSTRACT

A ladder for use as a fire escape has two stiles comprising telescopically collapsible tube sections, a plurality of rungs each secured to the upper end of two tube sections, each of the two sections being part of a respective one of the two stiles, and retractable spring-biased pins supported by the lateral ends of the rungs and engageable in holes in the walls of the tube sections to lock the tube sections to one another in the extended state of the ladder. The ladder is capable of being suspended from the uppermost tube sections of the stiles and the holes in the walls of the tube sections in which the sprung pins are engageable are dimensioned to allow free play between the pins and the holes in at least the axial direction of the tubes.

### CROSS-REFERENCE TO RELATED APPLICATIONS

This application is the §371 National Stage Entry of International Application Serial No. PCT/IB2013/055712, filed on Jul. 11, 2013, which claims the benefit of United Kingdom Patent Application Serial No. GB 1213255.1, filed on Jul. 25, 2012, the contents of which applications are herein incorporated by reference in their entirety.

### FIELD OF THE INVENTION

The present invention relates to a telescopically collapsible ladder intended for use as a fire escape.

### BACKGROUND OF THE INVENTION

Telescopically collapsible ladders are known in which the stiles are formed of tube sections that fit one inside the other and each rung is secured to the top of one section of each stile. In the extended state of the ladder, the tube sections are locked relative to one another by sprung pins mounted in, or on, the lateral ends of the rungs which engage in holes in the walls of the tube sections.

### SUMMARY OF THE INVENTION

The present invention seeks to provide a telescopically collapsible ladder which is suited for use as a fire escape, being designed to be extended safely by the action of gravity while the ladder is being held by its uppermost tube sections or uppermost rung.

According to the present invention, there is provided a ladder for use as a fire escape having two stiles comprising telescopically collapsible tube sections, a plurality of rungs each secured to the upper end of two tube sections, each of the two sections being part of a respective one of the two stiles, and retractable spring-biased pins supported by the lateral ends of the rungs and engageable in holes in the walls of the tube sections to lock the tube sections to one another in the extended state of the ladder, characterised in that the ladder is capable of being suspended from the uppermost rung or uppermost tube sections of the stiles and the holes in the walls of the tube sections in which the sprung pins are engageable are dimensioned to allow free play between the pins and the holes in at least the axial direction of the tubes.

Known collapsible ladders. for example as taught by EP 0527766, are designed to stand on the ground and for their weight to be supported by the lowermost section. The ladders are extended manually by lifting the upper rungs until their pins engage in the holes of the tube sections to lock them to one another. The pins fit snugly in the holes to prevent any movement of the rungs relative to one another. Dampers are also commonly provided to ensure that during collapse the rungs move slowly relative to one another to avoid trapping the fingers of the operator between two rungs.

By contrast, the ladder of the present invention is intended to open automatically by the action of its own weight. After the uppermost tube sections or rung has been secured to a safely mounted bracket, the ladder is merely suspended from the bracket and its own weight will result in the extension of the telescopic stiles. It is preferable to minimise damping so that the ladder may be deployed as quickly as possible.

However, because of the speed of relative movement of the tube sections, there is a risk that the pins may miss engaging in the holes in the tube walls, thereby allowing a rung to descend beyond its locking position, rendering the ladder unsafe.

To safeguard against such an occurrence, the holes in the walls of the tube sections are axially elongated. This ensures that the pins will always engage in the holes when the ladder is deployed. The free play will allow a rung to be moved upwards to reduce its distance from the rung above it. However, as people using a fire escape only ever apply a downward force to the rungs such free play will not be of an practical consequence.

In order to collapse the ladder after use, it is first removed from its support bracket and the pins are manually retracted, one pair at a time, starting with the pins of the lowermost rung and working upwards.

In a preferred embodiment of the invention, a pivotable bracket may be provided on the lowermost section of the ladder to act as a stand-off in order to maintain a distance between the ladder and the wall against which it leans.

### BRIEF DESCRIPTION OF THE DRAWINGS

The invention will now be described further, by way of example, with reference to the accompanying drawings, in which:

FIG. 1 shows a section through the top three sections of a known collapsible ladder in its collapsed position,

FIG. 2 is a perspective view of a tube section of one of the stiles of FIG. 1,

FIG. 3 is a section through the top three sections of a collapsible ladder of the invention, with lowermost of the three sections shown in its extended position,

FIG. 4 is a perspective view similar to that of FIG. 2 showing a tube section of one of the stiles of the ladder shown in FIG. 3,

FIG. 5 shows an embodiment of the invention in which the lowermost section is fitted with a folding stand-off bracket, the bracket being shown in its folded away position,

FIG. 6 shows the embodiment of FIG. 5 with the stand-off bracket pivoted into its deployed position, and

FIGS. 7 and 8 shown a stand-off bracket attachment in its deployed and folded away positions, respectively.

### DETAILED DESCRIPTION OF PREFERRED EMBODIMENTS

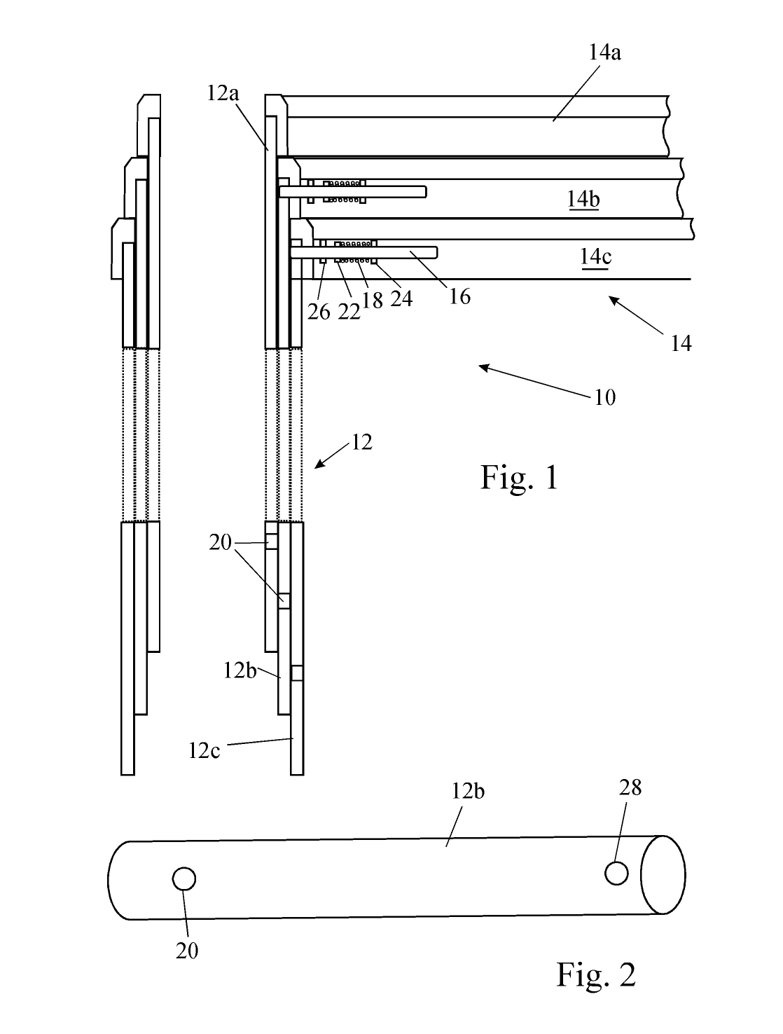

FIG. 1 shows a section through only one half of the top three sections of a conventional telescopically collapsible ladder, which may typically have between ten and fourteen such sections. The ladder 10 has stiles 12 and rungs 14. The stiles 12 are formed of tube sections 12a, 12b and 12c of progressively larger diameter that are received snugly one inside the next. The tube sections can slide relative to one another to lengthen and shorten the stiles in the same manner as the tubes of a telescope.

At each of their ends, the rungs 14a, 14b and 14c are firmly and permanently secured to the upper end of a tube section 12a, 12b, 12c of a respective one of the two stiles 12. As the stiles 12 are lengthened, the rungs move apart to an extended or deployed position and as the stiles are shortened, the rungs stack against one another as shown in FIG. 1 in a compact storage configuration.

Once the ladder is deployed, it is of course necessary to prevent the tube sections from telescoping into one another when a person is standing on the ladder. In order to lock the tube sections relative to one another, pins 16 are mounted in the ends of the rungs to engage in holes 20 near the lower ends of the tube sections 12a, 12b, 12c. Each pin 16 is biased by means of a spring 18 that acts between a collar 22 on the pin 16 and a stationary abutment 24 secured to the rung 14. A manually operable retracting lever 26 is slidable by means of a button (not shown) mounted on the front face of each rung.

FIG. 2 shows the tube section 12b when separated from the remainder of the stile tubes. In addition to the hole 20 receiving the pin 16 of the rung 14c, the tube section 12b also has a hole 28 through which the pin 16 of the rung 12b passes to engage in the hole 20 of the tube section 12a.

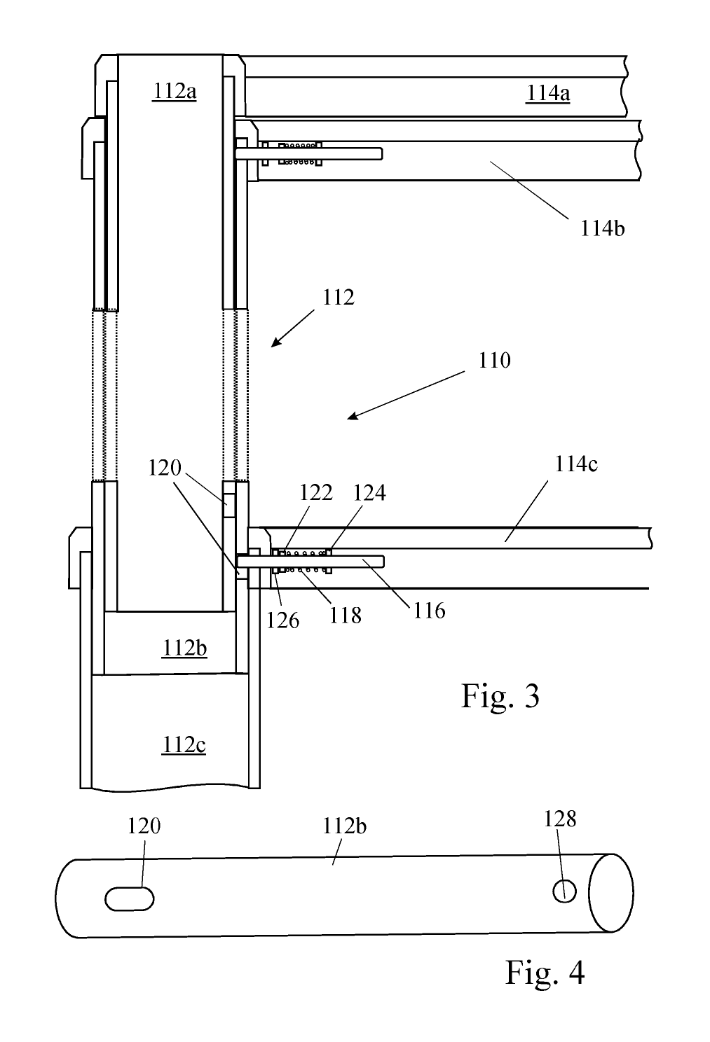

The ladder shown in FIGS. 3 and 4 is essentially the same as that shown in FIGS. 1 and 2 and to avoid repeating the description, like components have been allocated like reference numerals but in the 100 series. The primary difference between the embodiment of the invention shown in FIGS. 3 and 4 and the prior art resides in the fact that the holes 120 in which the pins 116 engage are axially elongated and may additionally be slightly widened in order to ensure that the pins 116 will always engage in the holes 120 even if the tube sections of the ladder are moving relative to one another at speed.

In use, the fire escape ladder of FIG. 3 is stored in its collapsed state near a window of a building. A bracket is securely mounted on the exterior of the building by the window to support the ladder when it used to be deployed. The bracket is designed to engage fixtures on only the top section of the ladder and it may simply engage under the uppermost rung. Once the top rung has been secured to the wall in this manner, the remainder of the sections are released and allowed to fall under the action of gravity. No damping is provided between the sections, which are therefore able to move relative to one another quickly. As each rung 114 lines up with the hole 120 of the tube section connected to the rung above it, its pin 116 is pushed out by its spring 118 to engage in the hole of and thereby lock the tube sections to one another.

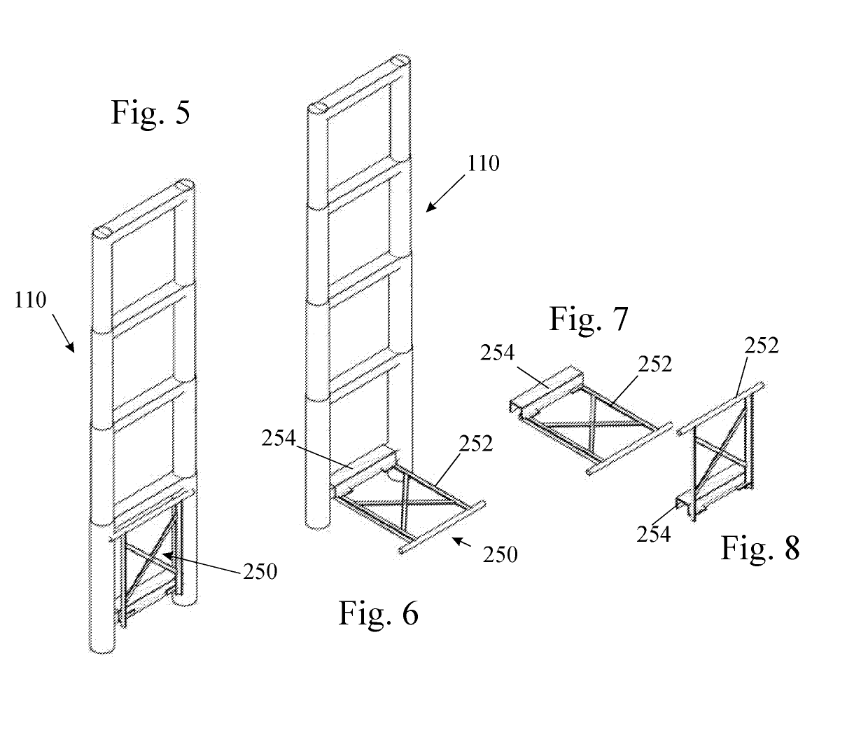

As it is difficult to climb down a ladder that is lying parallel to a wall, it is desirable to provide a stand-off bracket to hold the lower end, or some intermediate section, of the ladder away from the wall from which it has suspended. Such a stand-off bracket 250 is provided in the case of the embodiment shown in FIGS. 5 and 6. The bracket 250 is in the form of an open frame 252 pivotably connected to a U-shaped channel 254 that fits over one of the rungs of the ladder. A toggle action spring may be used to hold the open frame 252 of the bracket 250 in an over-centre position.

The stand-off bracket of FIGS. 5 and 6 has the form of a separable attachment, as shown in FIGS. 7 and 8 but it is alternatively possible for the frame 252 to be pivoted directly to one of the rungs of the ladder.

To fold away the ladder after use, it is first lifted off the wall bracket and allowed to rest on the ground on its lowermost section. All sections of the ladder will then move slightly to take up the lost motion between the pins 116 and the axially elongated holes 120. The pins 116 of the lowermost section of the ladder are then retracted against the action of their spring 118 using the manually operable levers 126. This will allow the next to lowermost ladder section to collapse until its rung stacks against the lowermost rung. The process is then repeated one rung at a time, working from upwards the lowermost section to the uppermost section of the ladder 110.

1. A ladder for use as a fire escape having two stiles comprising telescopically collapsible tube sections, a plurality of rungs each secured to the upper end of two tube sections, each of the two sections being part of a respective one of the two stiles, and retractable spring-biased pins supported by the lateral ends of the rungs and engageable in elongate holes in the walls of the tube sections to lock the tube sections to one another in the extended state of the ladder,
wherein the ladder is capable of being suspended from the uppermost tube sections of the stiles and the elongate holes in the walls of the tube sections in which the sprung pins are engageable are dimensioned to allow free play between the pins and the holes in at least the axial direction of the tubes.

2. The ladder as claimed in claim 1, further comprising a stand-off bracket secured to a section of the ladder to maintain a distance between the lower end of the ladder and a wall against which the ladder leans.

3. The ladder as claimed in claim 2, in which the stand-off bracket is formed as an attachment separable from the ladder.
